(19) United States
(12) Patent Application Publication
(10) Pub. No.: US 2009/0056975 A1
(43) Pub. Date: Mar. 5, 2009

(54) Transmission wire

(76) Inventor: Christina Lin, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/230,356

(22) Filed: Aug. 28, 2008

(30) Foreign Application Priority Data
Aug. 31, 2007 (TW) 96214573
Aug. 31, 2007 (TW) 96214580

(51) Int. Cl. H01B 7/00; H01B 3/30

(52) U.S. Cl. 174/113 R; 174/110 R

(57) ABSTRACT

A transmission wire includes an insulated packaging layer, at least one conducting wire, and a flexible fixing wire. The conducting wire is set inside the insulated packaging layer. The flexible fixing wire and the conducting wire are set inside the insulated packaging layer in common. The transmission wire can be arbitrarily bend and fixed on a desired position or shape via setting the flexible fixing wire inside the insulated packaging layer. Hence, the electronic devices such as microphones or webcams can be stably supported to be used at the most appropriate angle or height, so, the practicability is increased.

### BACKGROUND OF THE INVENTION

1. Field of the Invention

The present invention relates to a transmission wire, and more particular to a transmission wire transmitting signals for electronic devices.

2. Description of Related Art

An electrical connector electronically connects between two electronic devices. The electrical connector is equipped with a transmission wire, the length of the transmission wire is appropriate to meet with the distance of the electronic devices so as to transmit signals. Hence, the transmission wire is a necessary component in the 3C industry. The transmission wire can connect with at least two electronic devices to transmit signals or electric power. Hence, the quality of the transmission wire nearly relates to the operation stability and the life-span of the electronic devices.

The transmission wires on the current market are made of ordinary wires, however, along with the rapid development of the electrical connectors and the PC fittings, the types and the functions of the transmission wires are more and more diverse. Furthermore, some electronic devices need to be supported and fixed on some particular appropriate positions to be used (such as webcams or microphones). However, the transmission wires of the prior arts haven't the supporting and fixing functions. The webcams or the microphones tend to be fixed on some appropriate positions via other fixing manners. Moreover, the transmission wires of the prior arts are messy and easily tangled, so it is troublesome to put the transmission wires in order.

Consequently, because of the technical limitations of described above, the applicant strives via real world experience and academic research to develop the present invention, which can effectively improve the limitations described above.

### SUMMARY OF THE INVENTION

The object of the present invention is to provide a transmission wire, which can be arbitrarily bent and fixed on a desired position and with a desired shape.

For achieving the object described above, the present invention provides a transmission wire, the transmission wire includes an insulated packaging layer; at least one conducting wire is set inside the insulated packaging layer; and a flexible fixing wire is set inside the insulated packaging layer with the conducting wire.

The advantages of the present invention are:

The transmission wire can be arbitrarily bend and fixed on a desired position and with a desired shape via setting the flexible fixing wire inside the insulated packaging layer. Hence, the electronic devices such as microphones or webcams can be stably supported to be used at the most appropriate angle or height, so, the practicability is increased.

Further, because the transmission wire of the present invention can be bent and fixed, it is convenient to put the transmission wire in order, and the situation of the transmission wire is messy or tangled around the PC can be avoided.

The features and technology of the present invention can be further understood by reference to the following detailed description when taken in conjunction with the accompanying drawings, and the accompanying drawings are provided only for reference and illustration and not for limiting the present invention.

### BRIEF DESCRIPTION OF THE DRAWINGS

FIG. 1 is a perspective view of a transmission wire according to a first embodiment of the present invention;

FIG. 2 is a cutaway view of the transmission wire according to the first embodiment of the present invention;

FIG. 3 is a perspective view of a transmission wire according to a second embodiment of the present invention;

FIG. 4 is a cutaway view of the transmission wire according to the second embodiment of the present invention;

FIG. 5 is a perspective view showing the transmission wire is bent and fixed according to the present invention;

FIG. 6 is a perspective view showing the transmission wire is set with electrical connectors and bent and fixed according to the present invention;

FIG. 7 is a perspective view showing the transmission wire is set with electrical connectors and erectly fixed according to the present invention;

FIG. 8 is a perspective view showing the electrical connectors of the transmission wire connects with a first electronic device and erectly supports a second electronic device according to the present invention; and

FIG. 9 is a perspective view showing the transmission wire bundles and erectly supports the second electronic device according to the present invention.

### DETAILED DESCRIPTION OF PREFERRED EMBODIMENTS

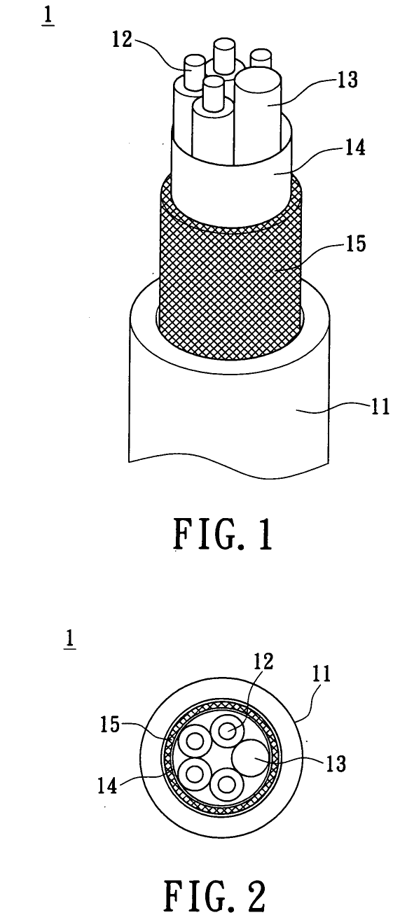

Please refer to FIGS. 1-8 showing a transmission wire of the present invention, the transmission wire includes an insulated packaging layer 11, at least one conducting wire 12, and a flexible fixing wire 13.

Please refer to FIG. 1 and FIG. 2 showing a first embodiment of the present invention. The insulated packaging layer 11 is made of insulating material and can effectively insulate the electricity transmission from outside interference, and thereby preventing the transmission wire 1 from being shorted or interfered by noises.

In the present embodiment, there is a plurality of the conducting wires 12, and the conducting wires 12 are set inside the insulated packaging layer 11. The external diameter of the insulated packaging layer 11 is 3.0 mm-9.0 mm. The insulated packaging layer is made by an integral forming process of Polyvinylchloride (PVC).

The surfaces of the conducting wires 12 are respectively packaged with the insulated material to avoid shorting during the transmission and avoid damage to the electronic devices.

The flexible fixing wire 13 and the conducting wires 12 are set together inside the insulated packaging layer 11. The flexible fixing wire 13 is made by an integral forming process of flexible metal material, such as iron wire or copper wire. The diameter of the flexible fixing wire 13 is from 0.6 mm to 2.0 mm. The flexible fixing wire 13 and the conducting wires 12 are set in a sheaf.

A separating layer 14 is set between the conducting wires 12 and the insulated packaging layer 11. The flexible fixing wire 13 is set inside the separating layer 14, that is, the separating layer 14 simultaneously packages the conducting wires 12 and the flexible fixing wire 13. The separating layer 14 is made of aluminum foil paper and can effectively insulate electromagnetic waves or other noises when the transmission wire 1 is transmitting signals, and thereby preventing the signals from being interfered by noises and the transmission quality from being degraded or interrupted.

A mesh grid 15 is set outside the separating layer 14. The mesh grid 15 is netlike and weaved by many iron wires which have the same diameter. Similar to the separating layer 14, the mesh grid 15 can effectively insulate electromagnetic waves or other noises.

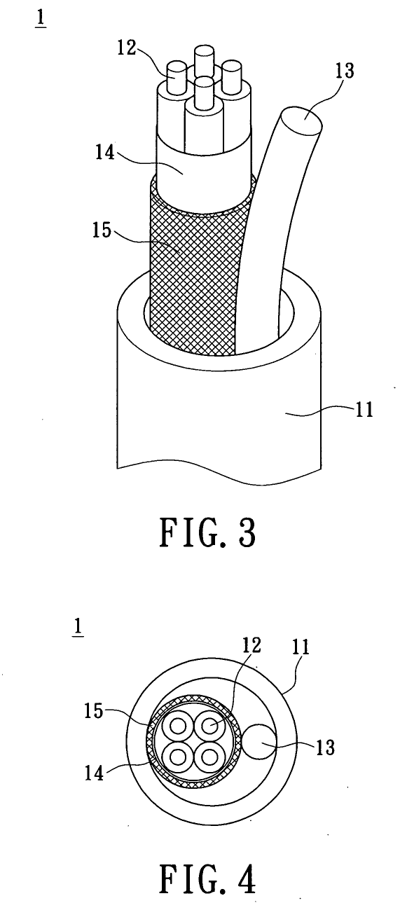

Please refer to FIGS. 3 and FIG. 4 showing a second embodiment of the present invention. The flexible fixing wire 13 is set between the separating layer 14 and the insulated packaging layer 11, the efficacy of which is the same as the first embodiment.

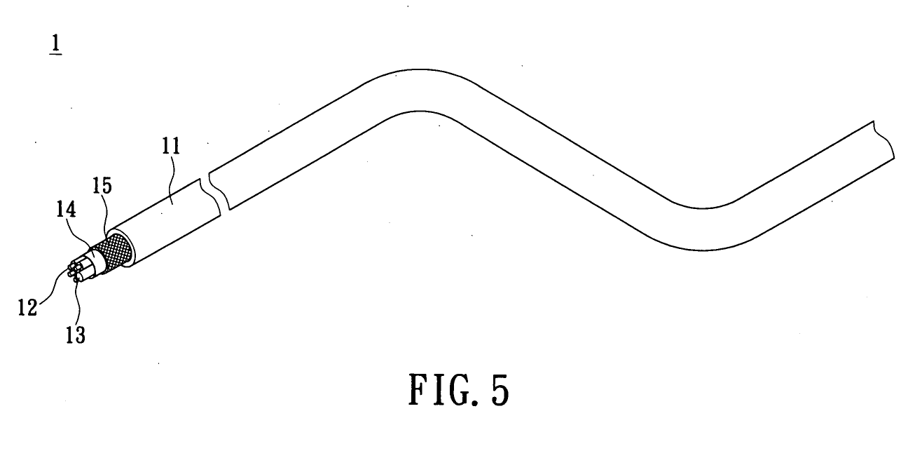

Please refer to FIG. 5, the transmission wire 1 can be arbitrarily bent and fixed on a desired position via setting the flexible fixing wire 13 inside the insulated packaging layer 11, and the transmission of the conducting wires 12 isn't affected.

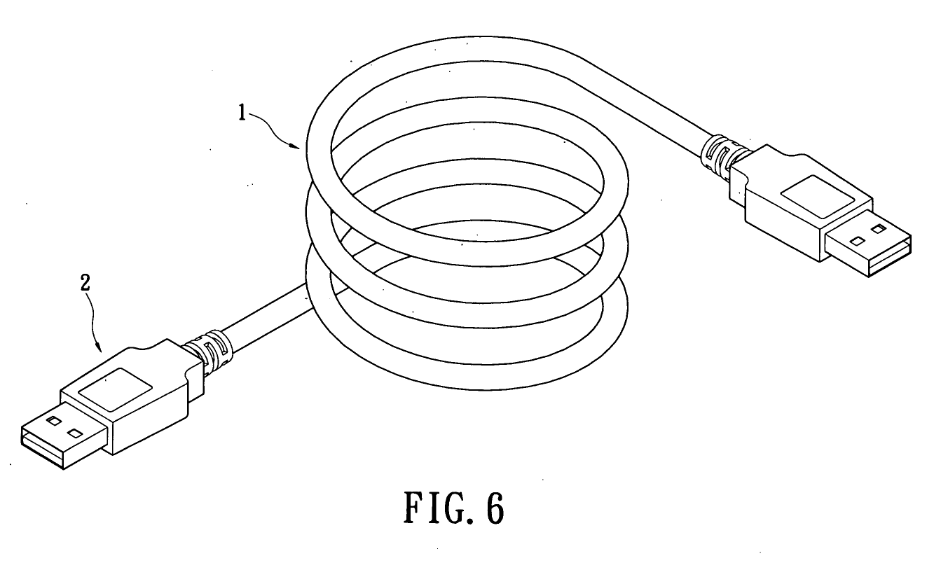

Please refer to FIG. 6, two electrical connectors 2 are respectively set on two ends of the transmission wire 1. The electrical connectors 2 can be USB (UNIVERSAL SERIAL BUS), VGA (Video Graphics Array), or other specifications of computer connectors ports which are too numerous too list, etc. When unused, the transmission wire 1 can be stored via coiling. Differ to the common transmission wires, because the transmission wire 1 can be bent and fixed, the transmission wire 1 won't spring, which can be messy; and the transmission wire 1 is convenient for being put in order.

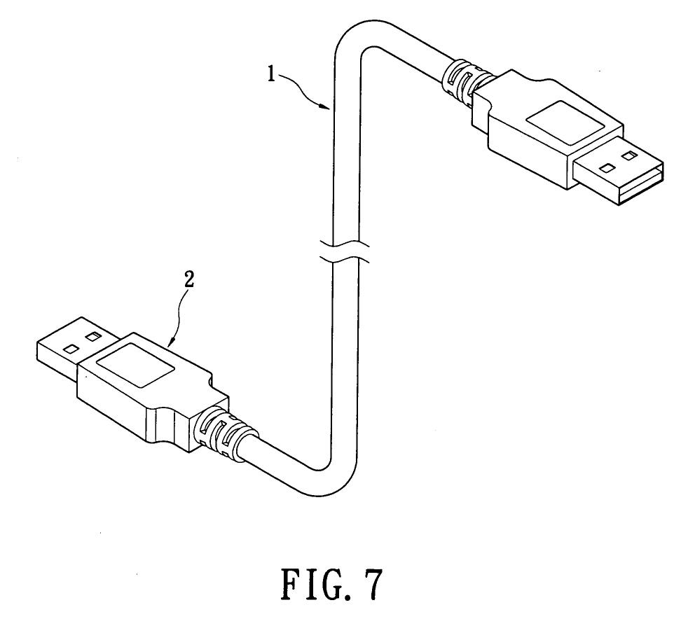

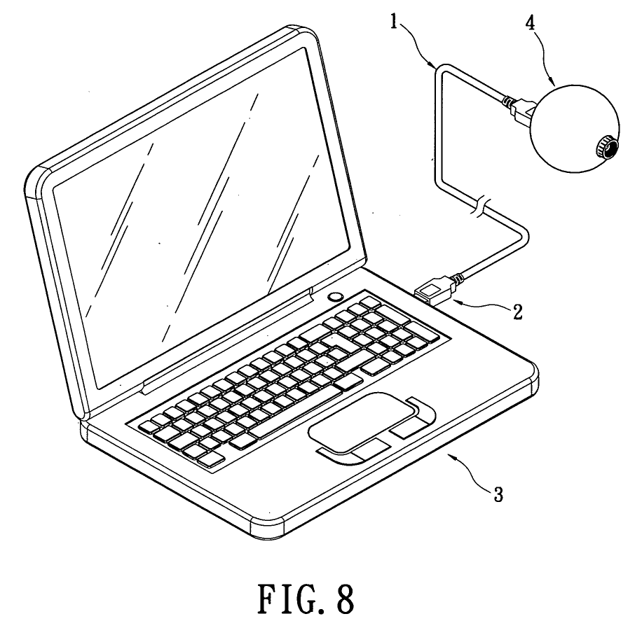

Please refer to FIG. 7 and FIG. 8, the two electrical connectors 2 electronically connect with the first electronic device 3 and the second electronic device 4 respectively, wherein the first electronic device 3 is a notebook computer, and the second electronic device 4 is a webcam. The first electronic device 3 and the second electronic device 4 are respectively set with a socket correspondly to the electrical connectors 2. The transmission wire 1 can be bent by 90 degree to be fixed and erectly supports the second electronic device 4 (webcam). Thus, the second electronic device 4 is fixed on a most appropriate position to accurately receive the aimed image, and thereby transmitting the image. Furthermore, the transmission wire 1 of the present invention can erectly support some objects with the weight of 250 grams or less stably.

It is worth to be mentioned that the electrical connectors 2 can be electronically connected with microphones or other electronic devices needing to be fixed except the aforementioned webcam.

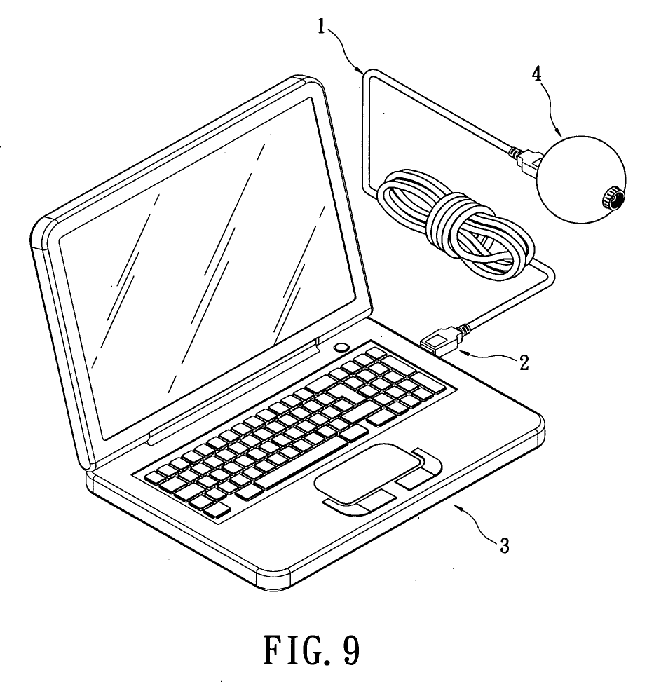

Please refer to FIG. 9, the transmission wire 1 bundles and erectly supports the second electronic device 4 simultaneously, and thereby avoiding the transmission wire 1 messy and tangled to effect the practicability.

The efficacy and the characteristics of the present invention are:

The transmission wire 1 can be arbitrarily bent and fixed on a desired position via setting the flexible fixing wire 13 inside the insulated packaging layer 11. Hence, the electronic devices such as microphones or webcams can be stably supported to be used at the most appropriate angle or height, so, the practicability is increased.

Further, because the transmission wire 1 of the present invention can be bent and fixed, so, it is convenient to put the transmission wire 1 in order, and the situation of the transmission wire 1 is messy and tangled around the PC can be avoided.

While the present invention has been described in terms of what is presently considered to be the most practical and preferred embodiments, it is to be understood that the present invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A transmission wire, comprising:
an insulated packaging layer;
at least one conducting wire setting inside the insulated packaging layer; and
a flexible fixing wire setting inside the insulated packaging layer with the conducting wire.

2. The transmission wire according to claim 1, wherein a separating layer is set between the conducting wires and the insulated packaging layer, the separating layer packages the conducting wire.

3. The transmission wire according to claim 2, wherein the separating layer is made of aluminum foil paper.

4. The transmission wire according to claim 2, wherein the flexible fixing wire and the conducting wires are set together inside the insulated packaging layer.

5. The transmission wire according to claim 2, wherein the flexible fixing wire is set between the separating layer and the insulated packaging layer.

6. The transmission wire according to claim 2, wherein a mesh grid is set outside the separating layer.

7. The transmission wire according to claim 1, wherein the flexible fixing wire is iron wire.

8. The transmission wire according to claim 7, wherein the diameter of the flexible fixing wire is from 0.6 mm to 2.0 mm.

9. The transmission wire according to claim 1, wherein the flexible fixing wire is copper wire.

10. The transmission wire according to claim 9, wherein the diameter of the flexible fixing wire is from 0.6 mm to 2.0 mm.

11. The transmission wire according to claim 2, wherein the external diameter of the insulated packaging layer is 3.0 mm to 9.0 mm.

12. The transmission wire according to claim 11, wherein the insulated packaging layer is made by an integral forming process of Polyvinylchloride (PVC).

13. The transmission wire according to claim 1, wherein two electrical connectors are respectively set on two ends of the transmission wire.

14. The transmission wire according to claim 13, wherein the electrical connectors are USB (UNIVERSAL SERIAL BUS).

15. The transmission wire according to claim 13, wherein the two electrical connectors electronically connect with a first electronic device and a second electronic device respectively.

16. The transmission wire according to claim 15, wherein the first electronic device is a notebook computer, and the notebook comprises a socket corresponding to the two electrical connectors.

17. The transmission wire according to claim 16, wherein the second electronic device is a webcam.
